(19) United States
(12) Patent Application Publication
(10) Pub. No.: US 2017/0206899 A1
(43) Pub. Date: Jul. 20, 2017

(54) BETTER COMMUNICATION CHANNEL FOR REQUESTS AND RESPONSES HAVING AN INTELLIGENT AGENT

(71) Applicant: Fitbit, Inc., San Francisco, CA (US)

(72) Inventors: Benjamin Haanes Bryant, Beverly Hills, CA (US); Christopher James Hendel, Redwood City, CA (US); Eric B. Migicovsky, Vancouver B.C. (CA)

(21) Appl. No.: 15/410,358

(22) Filed: Jan. 19, 2017

Related U.S. Application Data
(60) Provisional application No. 62/280,990, filed on Jan. 20, 2016.

(51) Int. Cl. G10L 15/22; H04W 4/12; G10L 15/26; H04L 29/08; G10L 15/30; H04B 1/3827; H04W 68/00

(52) U.S. Cl. CPC G10L 15/22; H04B 1/385; H04W 4/12; H04W 68/005; H04L 67/306; G10L 15/30; G10L 15/26; G10L 2015/223

(57) ABSTRACT

Verbal requests of a user of a wearable electronic device can be routed wirelessly so that a third party service and/or concierge service can facilitate carrying out the verbal request. The routines of the wearable device service capture a stream of audio segments corresponding to a verbal request of a user of the wearable electronic device. The wearable device service sends the stream of audio segments of the user to the associated mobile electronic device along with any speech-to-text translations of the verbal request. The wearable device service communicates with an intelligent agent, such an artificial intelligence engine and/or a human operator, to handle the speech to text translations of the verbal request along with the audio segments corresponding to the verbal request from the user of the wearable electronic device and fulfill that request.

### CROSS-REFERENCE

This application claims priority to U.S. Provisional Patent Application No. U.S. 62/280,990, filed Jan. 20, 2016, titled “BETTER COMMUNICATION CHANNEL FOR REQUESTS AND RESPONSES HAVING AN INTELLIGENT AGENT,” the disclosure of which is hereby incorporated herein by reference in its entirety.

### FIELD

The design generally relates to wearable electronics devices for sending verbal requests to a concierge type service and then receiving responses back from the concierge type service fulfilling the request.

### BACKGROUND

Typically, a wearable electronic device is used as a passive device, such as a watch to provide the time. The wearable electronic device generally does not allow the person wearing the device to interact with an external service to send a streaming audio request with a contextual metafile and then receive responses back from the service fulfilling the request.

### SUMMARY

In general, various methods and apparatuses are discussed for one or more wearable electronics devices to send one or more verbal requests to an on-line concierge type service hosted on an on-line platform and then receive responses back from the concierge type service fulfilling the verbal request(s). In an embodiment, a system is configured to facilitate routing verbal requests of a user of a wearable electronic device that is wirelessly coupled to an associated mobile electronic device. The wearable device service has data and one or more routines, storable in a memory in the wearable electronic device in an executable format. The routines of the wearable device service are configured to be executed by one or more processors in the wearable electronic device. The wearable device service is configured to establish a wireless communication link and cooperate with a partner mobile application in the associated mobile electronic device. The routines of the wearable device service are configured to capture a stream of audio segments corresponding to a verbal request of a user of the wearable electronic device. The wearable device service cooperates with a microphone in the wearable electronic device to generate the stream of audio segments corresponding to the verbal request of the user. The wearable device service is configured to send the stream of audio segments of the user to the associated mobile electronic device. The wearable device service is configured to communicate with an intelligent agent, such an artificial intelligence engine and/or a human operator, to handle the verbal request along with the audio segments corresponding to the verbal request from the user of the wearable electronic device and fulfill that request. The intelligent agent is configured to analyze the streamed audio segments corresponding to the verbal request. The intelligent agent communicates back with the wearable device service with one or more response to facilitate and carry out the verbal request from the user of the wearable electronic device.

### DRAWINGS

The multiple drawings refer to the example embodiments of the design.

FIG. 1 illustrates a block diagram of an example communication channel for requests and responses between one or more wearable electronic devices and an intelligent agent service executing on a concierge server.

FIG. 2 illustrates a block diagram of a portion of an example communication channel for requests and responses that provides audio files and text corresponding to a verbal request.

FIG. 3 illustrates a block diagram of another portion of an example communication channel for requests and responses that converts the verbal request into a text-based file and an audio file.

FIG. 4 illustrates a block diagram of a portion of an example communication channel for requests and responses that delivers the files associated with the verbal request for facilitation and carrying out by an appropriate third party service and/or concierge service.

FIG. 5 illustrates a block diagram of a portion of an example communication channel responses from the third party service and/or concierge service that are trying to facilitate and carrying out the verbal request of the user of the wearable device service.

FIG. 6 illustrates examples of requests and responses on an example display screen of the concierge server.

FIG. 7 illustrates a block diagram of an embodiment of remote access and/or communication by a wearable device to other devices on a network.

FIG. 8 illustrates a block diagram of an example computing system that may be part of an embodiment of one or more of the wearable devices discussed herein.

FIG. 9 illustrates a block diagram of an example wearable device.

FIG. 10 illustrates a flow graph of an example method of routing a request of a user of a wearable electronic device to the third party service and/or concierge service to facilitate and carrying out the verbal request.

FIG. 11 illustrates a block diagram of a portion of an example communication channel for requests and responses with multiple wearable electronic devices and their associated mobile electronic devices.

While the design is subject to various modifications and alternative forms, specific embodiments thereof have been shown by way of example in the drawings and will herein be described in detail. The design should be understood to not be limited to the particular forms disclosed, but on the contrary, the intention is to cover all modifications, equivalents, and alternatives falling within the spirit and scope of the design.

### DESCRIPTION

In the following description, numerous specific details are set forth, such as examples of wearable electronic devices, named components, connections, number of databases, etc., in order to provide a thorough understanding of the present design. It will be apparent; however, to one skilled in the art that the present design may be practiced without these specific details. In other instances, well known components or methods have not been described in detail but rather in a block diagram in order to avoid unnecessarily obscuring the present design. Thus, the specific details set forth are merely exemplary. The specific details discussed in one embodiment may be reasonably implemented in another embodiment. The specific details may be varied from and still be contemplated to be within the spirit and scope of the present design.

In general, a system for routing verbal requests of a user of a wearable electronic device that is wirelessly coupled to an associated mobile electronic device is discussed. The wearable electronic device has a wearable device service/application that communicates with an intelligent agent, such an artificial intelligence engine and/or a human operator, to handle the verbal request from the user of a wearable electronic device and fulfill that request. The wearable device service includes data and one or more routines storable in an executable format in a memory of the wearable electronic device. The processors in the wearable electronic device can execute the routines of the wearable device service. The routines of the wearable device service can capture the stream of audio segments corresponding to verbal requests of a user of the wearable electronic device. The stream of audio segments corresponding to verbal requests can be generated by a microphone cooperating with the wearable device service in the wearable electronic device. The routine captures the verbal request of the user in both audio segments as well as speech to text of the verbal request and then routes the captured audio segments along with the speech-to-text file out to assist in fulfilling the verbal request. Having both the speech to text and captured audio segments helps make sense of the user's request when the translated text by itself may not be accurate or convey enough meaning as the captured audio segments. The wearable device service can cooperate with a partner mobile application on the associated mobile electronic device. The routines of the wearable device service can capture the stream of audio segments corresponding to the verbal requests of the user of the wearable electronic device. The stream of audio segments is the captured segments of the verbal request from the user from the wearable device service of the wearable electronic device. The wearable device service cooperates with a microphone in the wearable electronic device to generate the stream of audio segments, which is sent in segments to the associated mobile electronic device. The wearable device service can send the stream of audio segments corresponding to the verbal requests of the user to a partner mobile application in the associated mobile electronic device. The partner mobile application has data and routines that are storable in a memory in the associated mobile electronic device in an executable format. The processors in the associated mobile electronic device can execute the routines of the partner mobile application. The partner mobile application can communicate with an audio-proxy server and send the stream of audio segments to the audio-proxy server. The audio-proxy server sends the stream of audio segments to both an audio store server and database as well as to a speech to text server. In an embodiment, the wearable device service directly communicates with the audio-proxy server without going through the partner mobile application.

Note, the audio-proxy server can communicate with one or more mobile electronic devices and can receive multiple streams of audio segments from multiple mobile electronic devices. The audio-proxy server can time multiplex the received streams of audio segments from multiple mobile electronic devices. Each stream of multiplexed audio segments includes multiple audio segments put together using temporal multiplexing. The multiplexed stream of audio segments can include one or more verbal requests of the user of one or more wearable electronic devices.

The audio-proxy server can be further coupled to a speech-to-text server and can communicate with the speech-to-text server. The speech-to-text server can receive the multiplexed stream of audio segments and can perform speech-to-text techniques, e.g., speech recognition processes, on the multiplexed stream of audio segments to generate voice-to-text files from the multiplexed stream of audio segments. The speech-to-text server can associate a probability of accuracy of the transcription of each voice-to-text file. In other embodiments, another server or other computing device can associate a probability of accuracy of the transcription of each voice-to-text file. The probability of accuracy indicates the confidence factor of how accurately the text words in the file correspond to the spoken words of the user. After speech recognition, the speech-to-text server can send back the voice-to-text files to the audio-proxy server. The audio-proxy server can receive back the speech to text file. The speech-to-text file comes from the speech to text server, which performed the speech-to-text process on the stream of audio segments.

The audio store server can convert and compile each of audio segments into a single audio (wave) file. In other embodiments, it may not be a wave file, but instead another type of audio file such as MP3, Opus, AIFF, FLAC, WMA Lossless, MPEG-4, and others. Yet, in an embodiment, the audio-proxy server can be configured to perform the functionality of converting each of audio segments into the single audio file. Thus, a new audio file is generated from the stream of audio segments being complied and processed in either the audio store server or the audio-proxy server.

In an embodiment, the audio-proxy server merely sends the voice-to-text file back to the corresponding mobile electronic device.

In an embodiment, the audio-proxy server can send both the voice-to-text file and its associated audio file back to the corresponding mobile electronic device. Note, in some instances the audio-proxy server sends just one or more hyperlinks to the voice-to-text file and the associated audio file rather than sending the actual files. Note, in other instances, a formatted file with a permanence characteristic is not being send but rather structured data with bits that have some contextual meaning to them and when received are parsed in a known particular way based on the transportation protocol to convey that structured data. In any of these implementations, the audio-proxy server may provide these ‘files’ to the other components in this system. The partner mobile application will receive a voice-to-text file and can also receive an audio file from the audio-proxy server. The partner mobile application of the associated mobile electronic device can send the voice-to-text file to the wearable device service of the wearable electronic device.

Again, the partner mobile application of the associated mobile electronic device can communicate with its associated wearable electronic device and send the voice-to-text file to the wearable device service of the wearable electronic device. After the wearable device service of the wearable electronic device receives the speech-to-text file, the wearable device service can perform additional actions. The wearable device service of the wearable electronic device can further attach context data including one or more of a user ID, a location of the user, etc., to the voice-to-text file and to create a meta file. The contextual data used to create a meta file is not limited to user ID or location, but can be any information obtained from the sensors on the wearable device or from the software on the wearable device itself, such as fitness information, personal information, calendar information, event information, altitude, heart rate, etc. The wearable device service then sends the meta file from the wearable electronic device to the associated mobile electronic device. The associated mobile electronic device can send the meta file and the audio file to a voice-API server for determining how best to facilitate and carry out the verbal request of the user. In an embodiment, the wearable device service of the wearable electronic device can perform additional functions such as displaying the words of the speech-to-text file so the user can verify its accuracy and/or modify the text to make it accurate.

Note, the audio store has captured the audio file so in some embodiments, the user of the wearable device service need not verify the accuracy of the text prior to the verbal request being sent for facilitation and carrying out by a third party service and/or concierge service. Thus, the audio store server can send associated audio file to the voice API server to be coupled with the text file at the voice API server. Overall, the voice-API server can receive 1) the voice-to-text file, 2) the context data, and 3) the audio file.

An example of a wearable electronic device can be a watch, a clip on fitness tracker, necklace, earring or ear bud, eyeglasses, belt, a necklace, lapel pin or other form of wearable device. In another example, the wearable electronic device may be a smart watch such as the “Pebble Time™,” “Pebble Round™,” or “Pebble Time Steel™” models. The following drawing and text describe various example implementations of the design.

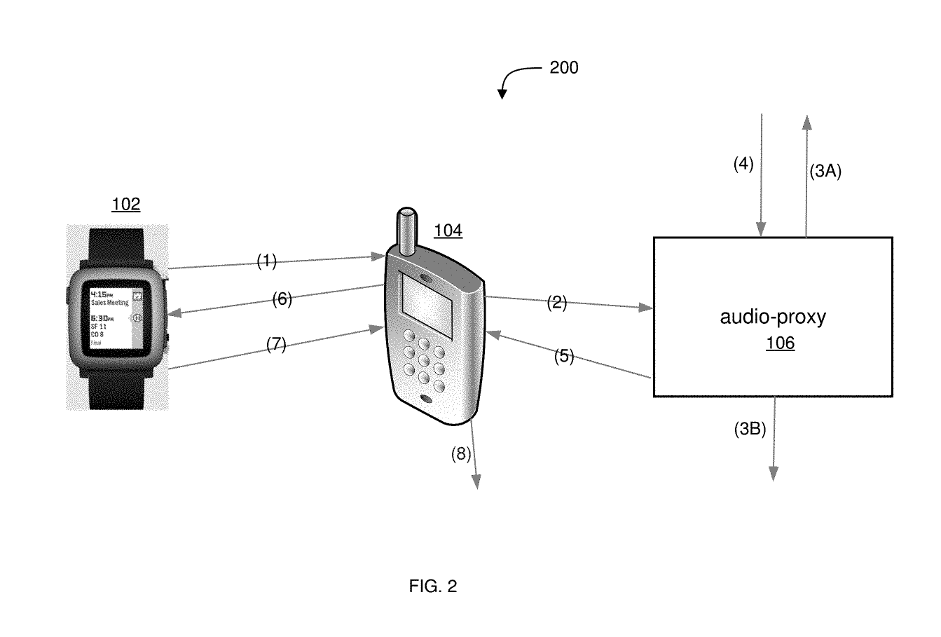

FIGS. 2-5 illustrate an example sequence of steps between various components of this system. In an embodiment, the method of routing requests of a user of a wearable electronic device associated with a mobile electronic device includes a number of example steps. The verbal request of the user may be spoken words and/or typed words in the verbal request. The verbal request of the user can additionally include content such as images/JPEGs, hyperlinks, etc. The steps in FIGS. 2-5 may be as follows.

(1) The wearable electronic device 102 can capture and then send a stream of audio segments to the mobile electronic device 104. Overall, the wearable device service can 1) establish bi-directional communications to cooperate with the associated mobile electronic device, 2) capture, the stream of audio segments corresponding to verbal requests of the user of the wearable electronic device that are generated by a microphone, and 3) send, in segments, the stream of audio segments of the user's verbal request to the associated mobile electronic device.

(2) The mobile electronic device 104 can send the stream of audio segments to the audio-proxy server 106. Overall, the partner mobile application can 1) receive the stream of audio segments associated with a verbal request of the user from the wearable device service of the wearable electronic device, 2) communicate with an audio-proxy server and send the stream of audio segments to the audio-proxy server, 3) receive, in response, a voice-to-text file from the audio-proxy server such that the voice-to-text file is a result of performing a speech-to-text technique on the stream of audio segments, 4) send the voice-to-text file to the wearable device service of the wearable electronic device, and 5) potentially receive an audio file generated from the stream of audio segments or a reference (e.g., link) of the audio file from the audio-proxy server such that the mobile device may associate 1) the speech to text file, 2) the meta data file, and 3) the audio file.

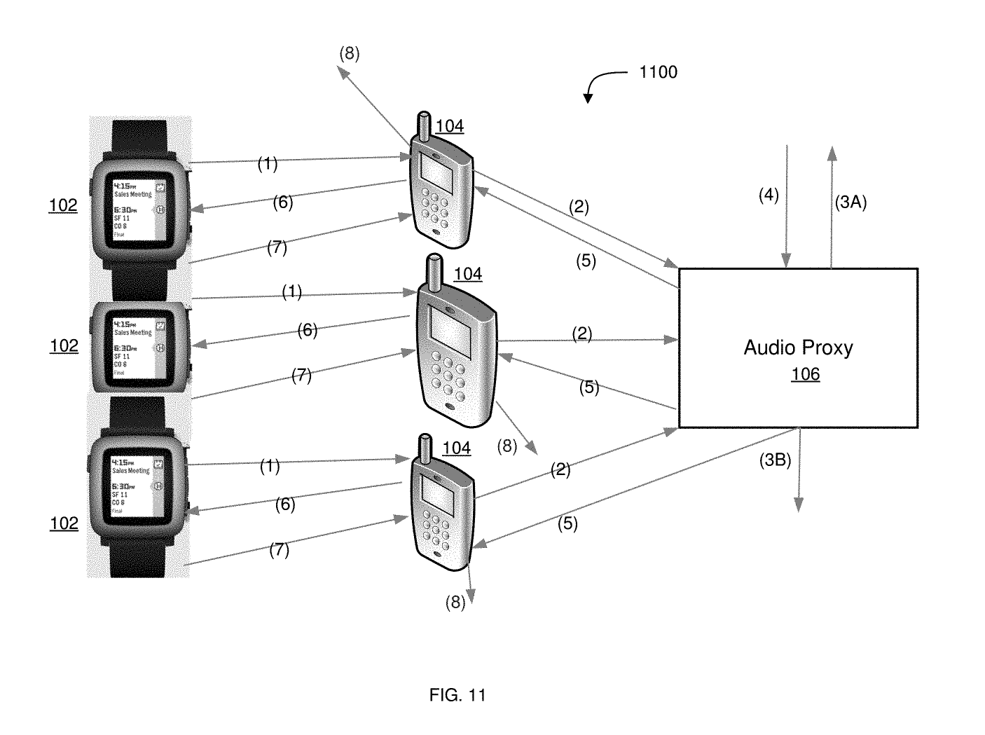

(3A) The audio-proxy server 106 can receive the stream of audio segments, multiplex them, and then send the multiplexed stream of audio segments to the speech-to-text server 108. The audio-proxy server 106 can receive one or more streams of audio segments (2) from one more mobile electronic devices 104 associated with the wearable electronic devices 102. The audio-proxy server 106 can perform time multiplexing of the received stream of audio segments and create a time-multiplexed stream of audio segments (See, for example, FIG. 11). In an embodiment, the audio-proxy server 106 can perform other forms of multiplexing and processing on the audio segments.

(3B) The audio-proxy server 106 can also receive the multiplexed stream of audio segments. The audio-proxy server 106 routes them to an audio store server to create audio files (wave files) from the stream of audio segments and store the audio files in the audio-store server and databases 110.

(4) The speech-to-text server 108 can perform speech to text recognition techniques on the multiplexed stream of audio segments and can create one or more voice-to-text files to be sent back to the audio-proxy server 106. The speech-to-text server can associate a probability of accuracy of the transcription of each voice-to-text file. The probability of accuracy indicates the confidence factor of how accurately the text words in the file correspond to the spoken words of the user.

(4B) In an embodiment, the audio-proxy server 106 can request and retrieve the audio file(s) from the audio-store server and databases 110. In an embodiment, the audio-store server and databases 110 may send the audio file(s) directly to a voice to API server 112.

(5) The audio-proxy server 106 can send the voice-to-text file back to the mobile electronic device 104 from which the stream of audio segments corresponding the voice-to-text file was received. In an embodiment, the audio-proxy server 106 can send the voice-to-text file and the corresponding audio file back to the mobile electronic device 104.

(6) The mobile electronic device 104 can then send the voice-to-text file back to the wearable electronic device 102 that generated the stream of audio segments.

(7) The wearable electronic device 102 can add context data such as the user ID and/or user's location to the voice-to-text and generate a meta file and then send the meta file to the mobile electronic device 104. After receiving the voice-to-text file, the wearable device service of the wearable electronic device can 1) attach context data including one or more of a user ID and a location of the user to the voice-to-text file and can create a meta file, and 2) send the meta file to the associated mobile electronic device. The associated mobile electronic device can then send the meta file and the audio file to a voice-API server for facilitating and carrying out the verbal request of the user. The wearable device service of the wearable electronic device can display the text of the speech-to-text file so the user can verify its accuracy and/or modify the text to make it accurate. Note that the audio store has captured the audio file so in some embodiments, the user of the wearable device service need not verify the accuracy of the text prior to the verbal request being sent for facilitation and carrying out by a third party service and/or concierge service.

(8) The mobile electronic device 104 can send the meta file to the voice-API server 112 for analysis and routing user requests. In an embodiment, the mobile electronic device 104 can send the meta file and the corresponding audio file to the voice-API server 112.

(9A) Overall, the voice-API server can receive 1) the voice-to-text file, 2) the context data, and 3) the audio file. After analyzing 1) the meta file, 2) the text of the speech to text file, and 3) the probability of accuracy of the transcription of each voice-to-text file, then the voice-API server 112 can determine where best to route the combination of the speech to text file, the meta file and the corresponding audio file. The voice-API server 112 can route these files to either i) an appropriate third party service or ii) the concierge server 120 for facilitating and carrying out/replying to user's request. An intelligent agent, such an artificial intelligence engine and/or a human operator, at the concierge service will handle the verbal request from the user of a wearable electronic device and fulfill that request. By default, the intelligent agent handles all user requests that the third party services do not readily handle. Thus, a human in combination with an intelligence engine can act like a personal assistant behind the microphone and wearable device service resident on the watch. This system enables the user of the watch to issue commands with actual people behind the microphone to carry out that verbal request.

Also, the user of the wearable electronic device does not need to worry about background noise, the user's accent, or other hard translatable words. The audio file and user's meta data help to understand the verbal request of the user when the server's speech to text file is not accurate enough.

(9B) The voice-API server 112 may determine, based on analysis results, that a given appropriate third-party website/server 114 services provided matches best to the nature of the user request indicated by the words in the text of the speech to text file. The voice-API server 112 can then route the combination of the meta file and the corresponding audio file to the appropriate third-party website/server 114 that best matches services provided to the nature of the user request indicated by the words in the text of the speech to text file. The voice-API server 112 is configured to act as the interface between the user of the wearable electronic device and the variety of third party services (Amazon, Uber).

(9C) The third-party website/server 114 can provide a reply and send the reply to the concierge server 120 and/or directly send the reply back to the voice API server. The voice API server is configured route replies from the third-party website/server 114 or the concierge server 120 back to the user of the wearable electronic device. In an example, the third-party website/server 114 can implement user's request and the reply may be a confirmation of facilitation and carrying out of the user's request. Alternatively, the third-party website/server 114 can send the reply in the form of a query asking questions or suggesting options regarding the facilitating and carrying out of the user's request to the concierge server 120.

(10) The concierge server 120 can send the result of i) its own facilitation and efforts to carrying out of user's request or ii) the reply of the third-party website/server 114 back to the voice-API server 112. The intelligent agent for the concierge server 120 can read the words of the speech to text file as well as listen to the audio file in order to determine what the user's request is. For example, the user may request, “Please order a rental car for me at Denver's Airport.” The intelligent agent for the concierge server 120 will determine the possible car rental companies working out of the airport at Denver and return an initial reply of the possible companies from which to choose. A bidirectional exchange of requests and responses will occur between the user of the wearable device and the intelligent agent to facilitate and carry out the verbal request.

(11A) and (12A) The voice-API server 112 can send the response that it has received from the concierge server 120 or from the appropriate third party service 114 through two or more communication pathways back to the wearable electronic device depending on which communication pathway is the most appropriate. For example, the voice-API server 112 can send the response via the cloud-based notification server 118 to the mobile electronic device 104 for any type of content when the user is in a good Wi-Fi or cellular connection area as well as the type of content of the response can be communicated via a notification.

(11B) and (12B) As another example, the voice-API server 112 can send the response that it has received from the concierge server 120 through the cloud-based SMS server 116 to the mobile electronic device 104 i) when the content is appropriate for SMS messages, such as TXT message or a JPEG, as well as ii) when the user is not currently located in a good Wi-Fi or cellular connection area. The SMS network has built-in redundancy so that the message and its content continues to be sent until a positive response has been received that the user's wearable electronic device has indeed received the SMS message. In an embodiment, the voice-API server 112 chooses the built-in redundancy of the SMS network for users located in bad connection areas.

(13) Upon receiving the response, the mobile electronic device 104 can send the response back to the wearable electronic device 102.

The exchange of communications between the user of the wearable electronic device and the concierge server 120 and/or the appropriate third party service 114 can continue using the above steps until the verbal request is facilitated and carried out in full. For example, the user may verbally request that the intelligent agent look up flights to Europe in Jan. 2016. The exchange of requests and responses may narrow down the countries, flight dates, airline, and eventually airport as well as indicated costs with the air flights.

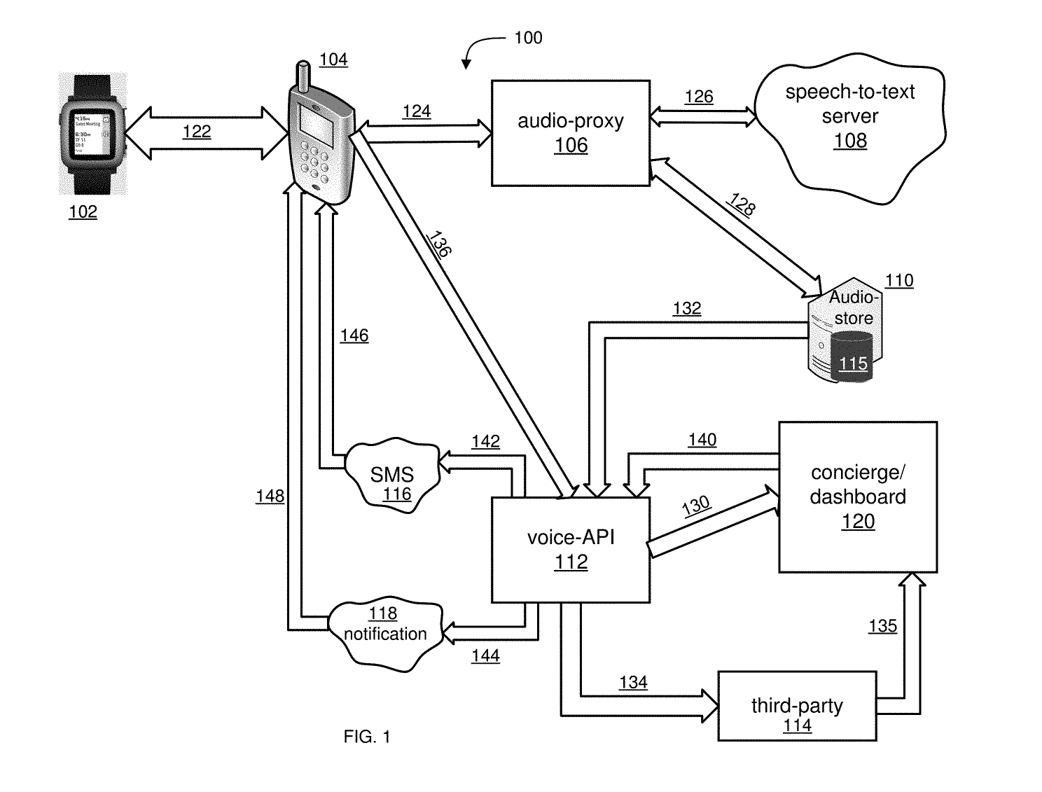

FIG. 1 illustrates a block diagram of an example communication channel for requests and responses between one or more wearable electronic devices and an intelligent agent service executing on a concierge server. The system 100 includes a wearable electronic device 102 coupled through a wireless connection 122 with the mobile electronic device 104. The wearable electronic device 102 and the mobile electronic device 104 can communicate and can send and receive signals including the stream of audio segments of the user requests through the wireless connection 122. The mobile electronic device 104 can communicate through the wireless or cellular connection 124 with the audio-proxy server 106. The mobile electronic device 104 can send and receive signals including stream of audio segments of user requests and text data to and from the audio-proxy server 106. The audio-proxy server 106 can communicate through the communication connection 126 with a cloud-based speech-to-text server 108. The audio-proxy server 106 can send and receive information with the speech-to-text server including stream of audio segments of user requests and the text file from a speech-to-text process. Also, the audio-proxy server 106 is coupled through connection 128 to the audio-store 110. The audio-proxy server can send the stream of audio segments to the audio-store 110 to be processed into an audio file, such as a .WAV file, and then stored in the databases 115.

Additionally, the system 100 can include a voice-API server 112 that can be coupled through connection 136 to the mobile electronic device and through the connection 132 to the audio-store 110. The voice-API server 112 can receive the user requests in text format from the speech to text file, audio format, or both through the connection 136 or through both connections 132 and 136. The voice-API server 112 is configured to analyze the content of the words of the text file as well as analyze the meta data and determine which service to route the user's request. The voice-API server 112 can route the user's request to one or more third-party service sites 114 and/or to a concierge service site 120. The voice-API server 112 can also be coupled through connection 134 to a third-party website 114 as well as through the connection 130 to a concierge server 120. The user requests can either be directly routed by the voice-API server 112 to the concierge server 120, where the intelligent agent for the concierge server can provide responses to the user requests. Also, the user requests can be routed to the third-party website 114, where the third-party website can respond to the user requests and can send its replies to the concierge server 120 through connection 135. For example, if the request was to buy an item, then the request could be routed to a call center third party service of, for example, Best Buy to handle that request. Alternatively, the possible items that come up from Amazon, or even the hyperlink to the results page on Amazon, could be sent to the user from this appropriate third party service. The concierge server 120 and/or the third party service can send its responses back to the voice-API server 112 through connection 140. Additionally, the voice-API server 112 can send the responses back to the mobile electronic device 104. The responses can be send back to the mobile electronic device 104 via connections 142 and 146 and through the cloud-bases SMS server 116, or via connections 144 and 148 and through the cloud-based notification server 118. After receiving the responses, the mobile electronic device 104 can send the responses back to the wearable electronic device 102 through connection 122. The exchange of communications between the user of the wearable electronic device and the concierge server 120 and/or the appropriate third party service 114 can continue using the above steps until the verbal request is facilitated and carried out in full.

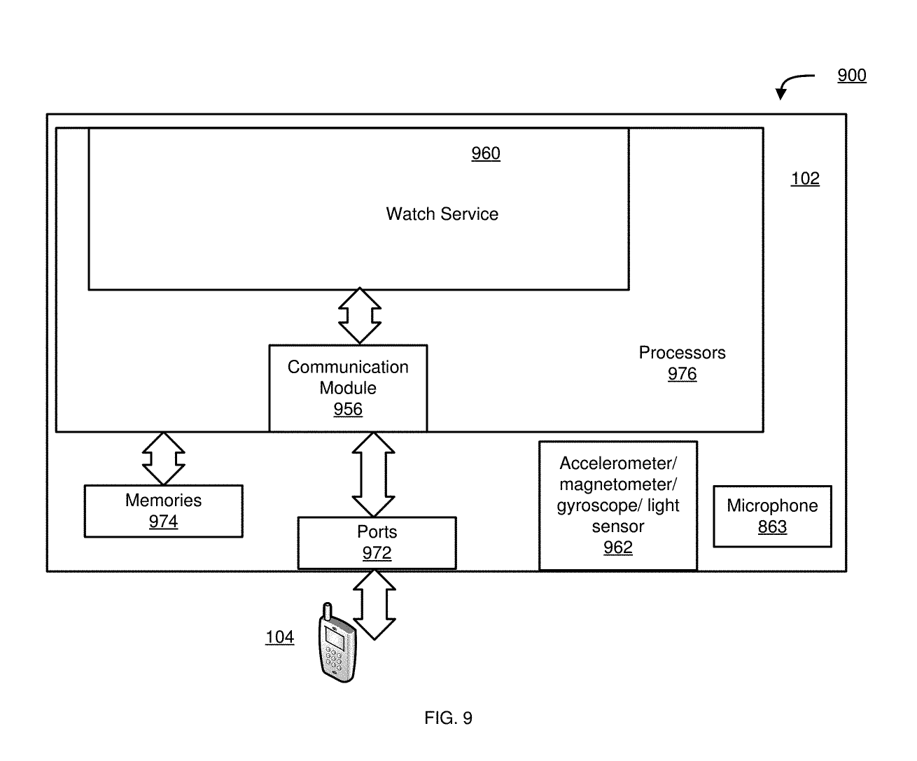

FIG. 9 illustrates a block diagram of an example wearable device. In an embodiment, the wearable device service 960 of the wearable electronic device 102 can include data and one or more routines. The wearable device service 960 can include data and one or more routines storable in an executable format in a memory 974 of the wearable electronic device 102. The processors 976 in the wearable electronic device 102 can execute the routines of the wearable device service 960. The routines of the wearable device service can capture the stream of audio segments corresponding to verbal requests of a user of the wearable electronic device that can be generated by a microphone 863 in the wearable electronic device. The routine captures the verbal request of the user in audio segments and then routes the captured audio segments out to assist in fulfilling the verbal request. The wearable device service 960 can cooperate with a partner mobile application on the associated mobile electronic device 104. The wearable device service can send the stream of audio segments of the user to the associated mobile electronic device.

In an embodiment, the partner mobile application of a mobile electronic device 104 can have data and one or more routines. The mobile electronic device 104 can be associated with the wearable electronic device 102. The data and routines can be storable in a memory in the associated mobile electronic device in an executable format. One or more processors in the associated mobile electronic device 104 can execute the routines of the partner mobile application.

Referring back to FIG. 1, in an example, the audio-proxy server 106 is cloud-based. In an example, the voice-API server 112 is also cloud-based; and thus, the partner mobile application on the mobile device connects to these servers over a wide area network such as the Internet or the cellular phone network.

In an embodiment, the audio-proxy server 106, not only can send stream of audio segments and audio files to the audio-store 110, but can also receive the audio filed from the audio-store 110 via connection 128.

In an example, the user requests can involve performing one or more actions and the requests may include acknowledgement of the actions. In another example, a response is either in text format, audio format, or both.

FIG. 2 illustrates a block diagram of a portion of an example communication channel for requests and responses that provides audio files and text corresponding to a verbal request. The block diagram 200 shows the wearable electronic device 102, the mobile electronic device 104, and the audio-proxy 106 of the system 100.

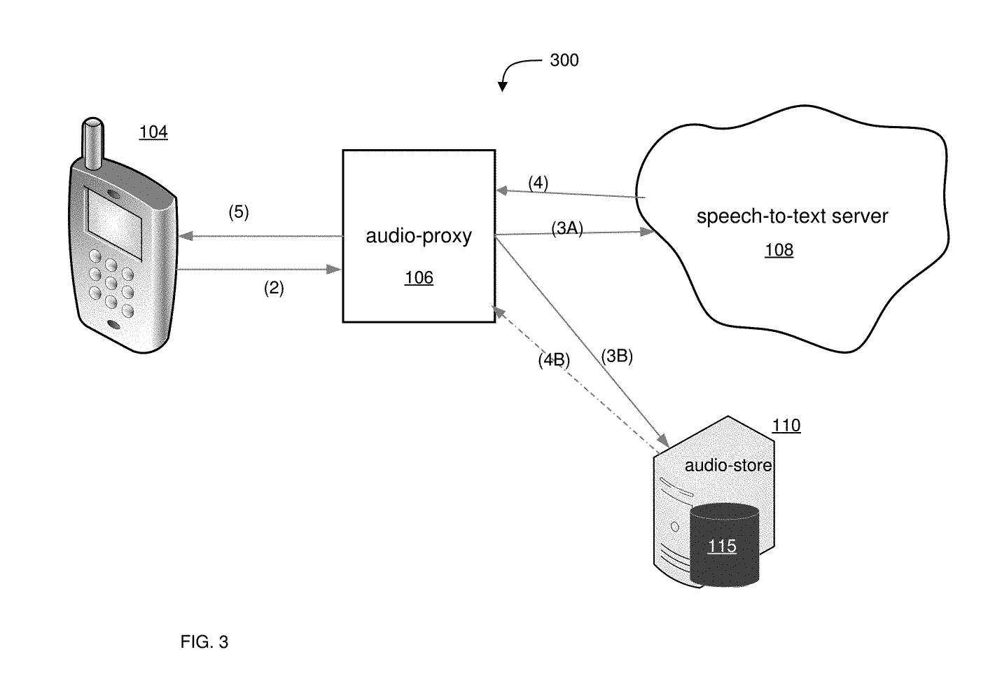

FIG. 3 illustrates a block diagram of another portion of an example communication channel for requests and responses that converts the verbal request into a text-based file and an audio file. The block diagram 300 shows the mobile electronic device 104, the audio-proxy 106, the speech-to-text server 108, and the audio-store 110 of the system 100.

In an embodiment, the audio-proxy server 106 includes one or more routines executing on one or more processors configured to perform the above functions.

Additionally, the audio-proxy server 106 can further cooperate with a cloud-based server and send the time-multiplexed stream of audio segments (3A) to the speech-to-text server 108 of the cloud-based server. The speech-to-text server 108 can perform one or more of speech-to-text techniques on the time-multiplexed stream of audio segments and create one or more voice-to-text files associated with stream of audio segments.

Also, the audio-store server 110 can create one or more audio files from the time-multiplexed stream of audio segments. Each audio file can be associated with a stream of audio segments corresponding to one or more verbal requests of each user. The audio-store server 110 can include one or more databases 115. In an embodiment, the audio-proxy server 106 can send the audio files to the phones (5) to be attached to corresponding meta files when sent by the mobile electronic devices to the voice-API server 112 for facilitating and carrying out the verbal requests. Alternatively, the audio-store server 110 can send the audio file directly to the voice API server 112 to be coupled with the meta data and text file. This would speed up the process instead of sending the audio file to the audio-proxy server 106, which sends the audio file to the mobile device 104, which then sends the package of the text file, the meta data, and the audio file to the voice API server 112.

In an embodiment, the speech-to-text server 108 can associate a certain percent probability to the voice-to-text file as a probability corresponding to an accuracy of speech-to-text recognition. Based on this probability, the voice API server can determine that analysis of the text file may not create a satisfactory result; and thus, directly route all of the files to the human operator at the concierge service to listen to the captured audio of the user. Equipped with the audio file and the user's location, the human operator may be able to determine what the user is truly asking for in their request.

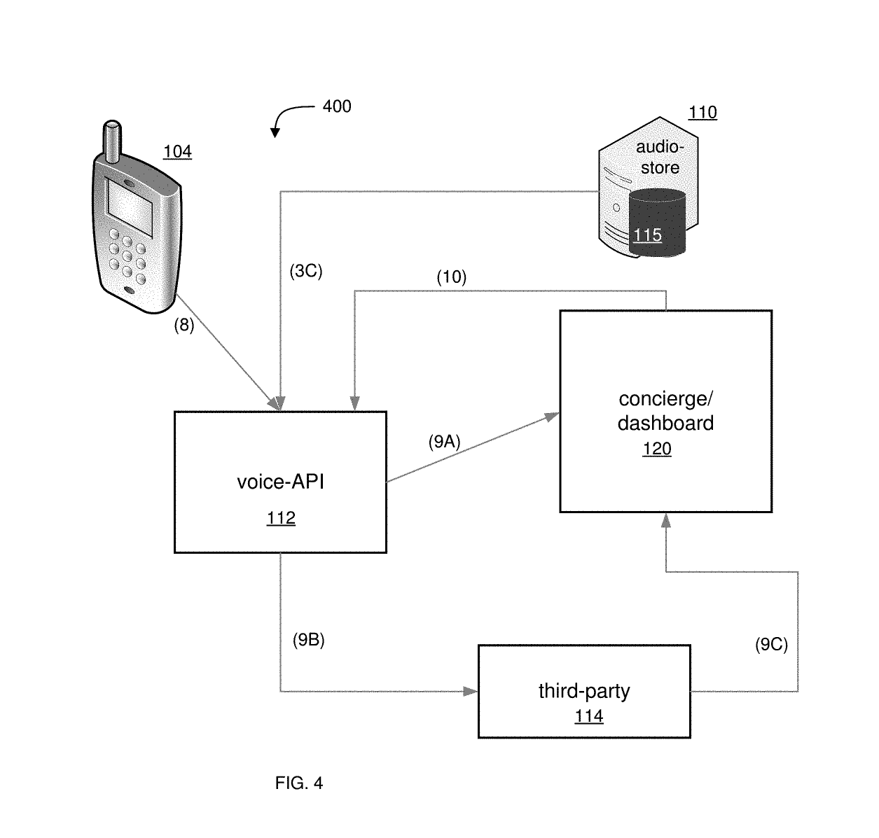

FIG. 4 illustrates a block diagram of a portion of an example communication channel for requests and responses that delivers the files associated with the verbal request for facilitation and carrying out by an appropriate third party service and/or concierge service. The block diagram 400 shows the mobile electronic device 104, the audio-store 110, the voice-API server 112, the concierge server and service 120, and the one or more cooperating third-party websites 114 of the system 400.

In an embodiment, the wearable device service of the wearable electronic device 102 can attach context data including a user ID and a location of the user to the voice-to-text file via attaching the meta file. The wearable device service can send (7) the voice-to-text file with the meta file from the wearable electronic device 102 to the associated mobile electronic device 104. In an example, the meta data further includes a model of the wearable electronic device, and/or a version of a software executing on the wearable electronic device, time of day, timeline related information, barometer, heart rate, and health activity of the user. Understanding the audio file with a full content of the user allows the responses to present a list of actions that are relevant to that user at the time of day and the place where the user is located. The associated mobile electronic device 104 can send (8) the voice-to-text file with the meta file as well as the audio file to the voice-API server 112 to be routed to the appropriate service for facilitating and carrying out the verbal request of the user.

Additionally, the voice-API server 112 can include one or more routines executing on one or more processors. The voice-API server 112 can collect and route verbal requests of users. The voice-API server 112 can receive both i) the voice-to-text file with the meta file from the associated mobile electronic device (8) and then ii) the audio file associated with the meta file directly from a database 115 of the audio-store server 110 (3C). The voice-API server 112 analyzes the content of the voice-to-text file with the meta file against the list of possible third party services and by default if none of the third party services can fulfill or understand the verbal request, then send the request and audio file to the concierge server. The voice-API server 112 can help to implement the verbal request of the user based on one or both of the meta file and the audio file.

Therefore, the voice-API server 112 can either receive both i) the text of the voice-to-text file with the meta file and ii) the associated audio file from the mobile electronic device (8), or can receive merely the text of the voice-to-text file with the meta file from the mobile electronic device (8) and then receive the associated audio file directly from the database 115 of the audio-store server 110 (3C).

In an example, the audio files are generated from the multiplexed stream of audio segments by either the audio-proxy server 106, or the audio-store server 110. In another example, an audio file can be generated from a stream of audio segments by the audio-proxy server 106, the audio-store server 110, or the voice-API server 112. In another example, the audio file can be created when all of the segments of the stream of audio segments corresponding to a request are complete and are received.

In an embodiment, the voice-API server 112 can analyze the meta file to find out what is an appropriate service in response to the request of the user. A first service of the voice-API server 112 can extract the words from the voice-to-text file embedded in this embodiment of the meta file. The first service of the voice-API server 112 can implement a natural language processing service to parse the content of the voice-to-text files. The first service of the voice-API server 112 can reference a tree of categories of possibilities of third party and concierge services to handle or service the incoming requests.

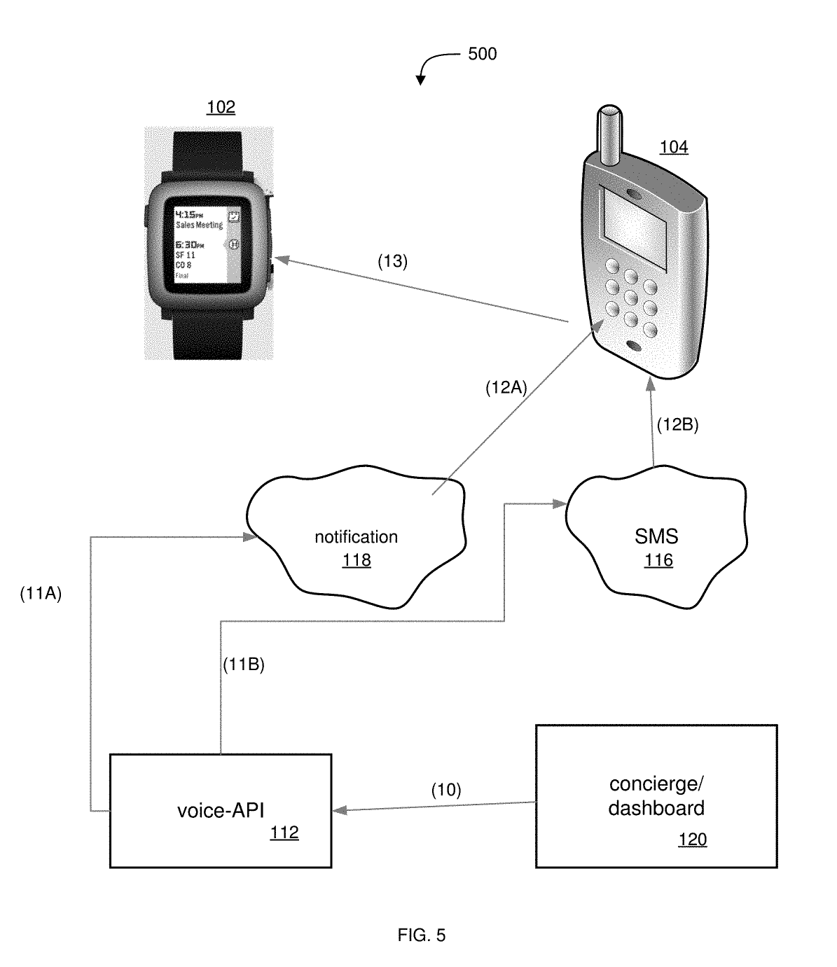

FIG. 5 illustrates a block diagram of a portion of an example communication channel responses from the third party service and/or concierge service that are trying to facilitate and carrying out the verbal request of the user of the wearable device service. The block diagram 500 shows the wearable electronic device 102, the mobile electronic device 104, the notification server 118, the SMS server 116, the voice-API server 112, and the concierge server 120 of the system 100.

In an embodiment, the first service of the voice-API server 112 can review the probability of accuracy corresponding to each voice-to-text file. Based on when the probability of accuracy is above or equal to a fixed threshold, such as 80% confident of the accuracy, the voice-API server 112 can send the files of the request onto a third party server without needing any additional assistance from the concierge service. Thus, in this instance, the voice-API server 112 can i) package the meta file and the corresponding audio file and send (9B) the package to a third-party website 114. The third-party website 114 can take actions to fulfill the request. The third-party website 114 can also send one or more replies to the Intelligent Agent service executing on a concierge server 120, which may be a combination of an intelligence engine and/or human assistants. In an example, 90% of user's verbal requests can be handled by a Natural Language Processing service and context tree in the intelligence engine and then the other 10% of the user's verbal requests are aided by a human operator. The context tree is configured to take real world “intents” and map them to the “intents” of the user making the request. The context tree may have a set of prescribed processes and then, out of that category, maps them to a known process to implement as the most appropriate response to the request.

Additionally, when the probability of accuracy is below the set threshold, then by default the voice-API server 112 can package the meta file and the corresponding audio file and send (9A) the package to the Intelligent Agent service executing on the concierge server 120. The Intelligent Agent service for the concierge service can analyze both the voice-to-text file, meta data and the corresponding audio file in order to determine what is being requested by the user and then determine how best to reply to the user or which third party server should fulfill the user's request.

In an example, the set threshold for the probability of accuracy is 80%. In another example, the probability of accuracy is 70%.

In an example, voice-API server 112 can parse the voice-to-text file to figure out what is the appropriate third party service to handle the request. The request can be directed to the third-party service 114 that can handle that type of request when there is an inferred intention in the user's request. For example, a request for a car rental can be sent to car rental service such as a call center. In another example, purchase requests for goods on merchant's site can be routed directly to that merchant's service site. A request for a ride can be directed to Uber's ride request service (e.g., service API). A request for directions can be directed to a Google maps service API. Requests that are more complex can be routed to the human operators at the concierge service site. Also, note, the user's verbal request consisting of a text-based file and the corresponding audio file is not a direct phone call to the call center. Accordingly, there is an asynchronous handling of the request. An audio file and corresponding text file go forward to the third party service and text, images, or audio actionable notifications come back to the user of the wearable device.

Additionally, after routing the request, the concierge server 120 can send (10) a response to the voice-API server 112. The API server 112 can then route the response through either of i) a cloud-based SMS server 116 (11B and 12B), or 2) a cloud-based notification server 118 (11A and 12A) to the mobile electronic device 104. The mobile electronic device 104 can then send the response to the associated wearable electronic device 102 (13). In an example, the response is sent when an appropriate action is taken or a sufficient response is received that can fulfill the user's request. The response can also request additional information from the user.

In an example, the routing of the response by the API server 112 through either of i) a cloud-based SMS server 116, or ii) a cloud-based notification server 118 can be based on either communication reliability, promptness of communication, or type and content of the response. In an example, the SMS server is used when the wearable electronic device and its associated mobile electronic device are in a bad communication environment.

Note, the initial request from the user may only be the start of a bidirectional communication between the user of the wearable electronic device and the artificial intelligence engine and/or human operator of the concierge server 120.

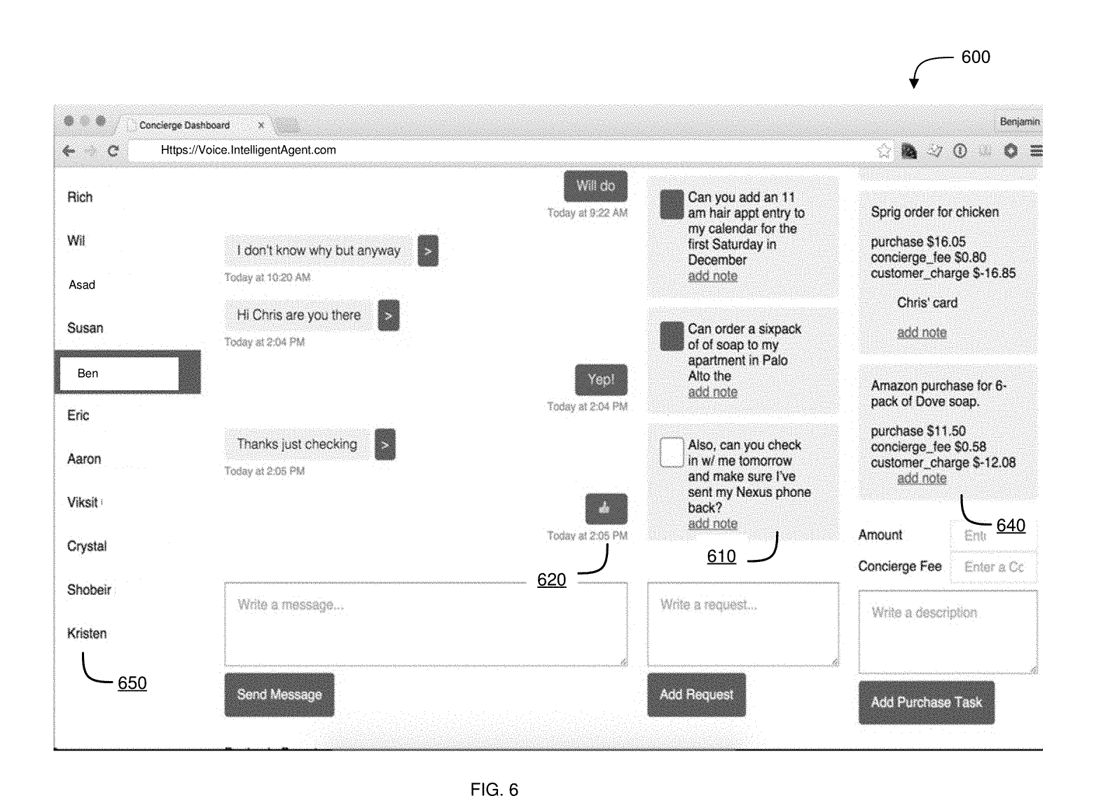

FIG. 6 illustrates examples of requests and responses on a display screen of the concierge server. The diagram 600 shows requests 610, responses 620 between different users 650, and the Intelligent Agent of the concierge service 120, and implemented tasks 640 in response to the user requests.

The human operator can also listen to the audio files of multiple users. The dashboard allows the human operator to review: a list of users of wearable electronic devices; a panel to track communication in a 1:1 situation with each user (e.g., chat window); ability to route tasks to automated systems and processes, for example third party services; a list of tasks associated with the verbal request; and an ability to bill the user for various transactional items.

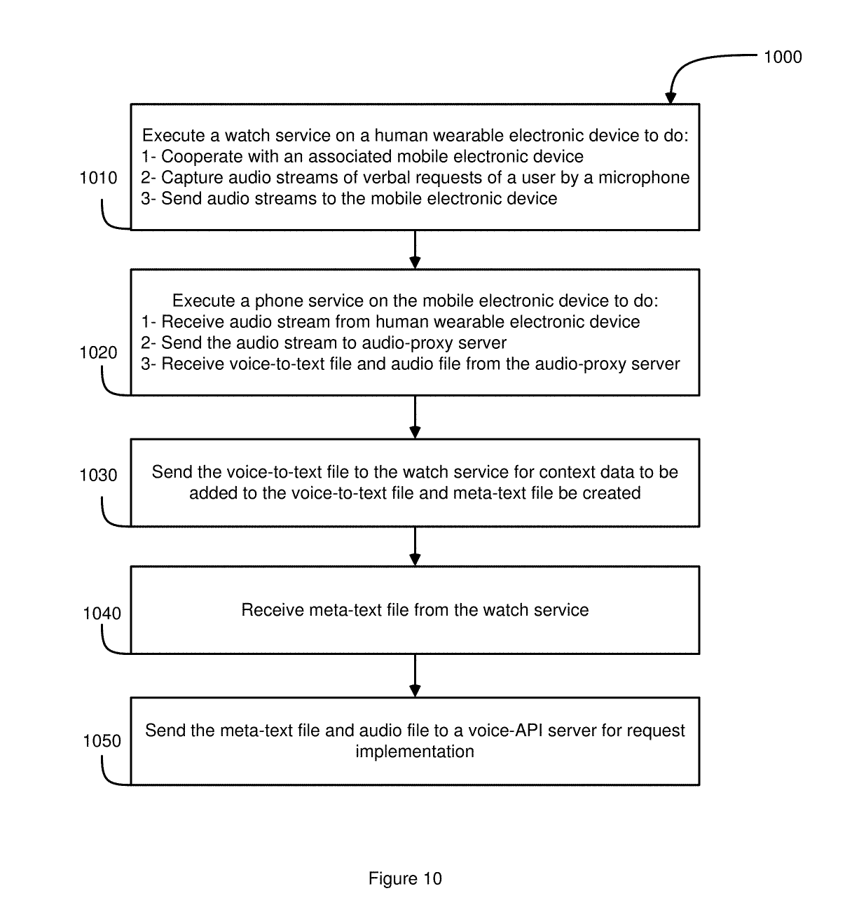

FIG. 10 illustrates a flow graph of an example method of routing a request of a user of a wearable electronic device to the third party service and/or concierge service to facilitate and carrying out the verbal request. The wearable electronic device is associated with a mobile electronic device. The flow diagram 1000 can be used for describing the method and the steps that may be performed out of literal order when logically possible. A wearable device service of the wearable electronic device can be executed: 1) to cooperate with the associated with a mobile electronic device; 2) to capture, via a microphone, the stream of audio segments of verbal requests of the user of the wearable electronic device; and 3) to send the stream of audio segments to the associated mobile electronic device (1010). As an example, the flow diagram 1000 can be executed on the system 900 of FIG. 9.

A partner mobile application of the associated mobile electronic device can be executed: 1) to receive a stream of audio segments from wearable electronic device; 2) to send the stream of audio segments to audio-proxy server; and 3) to receive voice-to-text file and audio file from the audio-proxy server (1020). The voice-to-text file can be a result of performing one or more speech-to-text techniques on the stream of audio segments. The audio file can be generated from the segments of the stream of audio segments being complied and then formatted into a proper software file format.

The voice-to-text file can be sent to the wearable device service for context data to be added to the voice-to-text file and meta file to be created (1030). In an example, the context data includes a user ID, a user location, a model of the wearable electronic device, and version of a software executing on the wearable electronic device.

The meta file is received from the wearable device service (1040). The meta-data that is the voice-to-text file plus the context data is received by the partner mobile application of the mobile electronic device.

The meta file and audio file are sent to a voice-API server for request facilitation and carrying out (1050). The facilitation and carrying out of the requests of the user of the wearable electronic device are described with respect to FIGS. 1, 4, and 5.

In an embodiment, the wearable electronic device is a smart watch that features a black and white memory LCD display screen, a programmable CPU, memory, storage, Bluetooth, a vibrating motor, a magnetometer, an ambient light sensor, other sensors and an accelerometer. These features extend the smart watch's use beyond just displaying the time on the display screen and into many roles including interacting with smartphone notifications, activity tracking, gaming, map display, golf tracking, and more. The smart watch is configured to communicate with and be compatible with Android and iOS devices. When connected to one of these devices via Bluetooth, the smart watch can (but may not need to) pair with that device and vibrate and display text messages, fitness information, emails, incoming calls, and notifications from social media accounts. The smart watch can also act as a remote control for the telephone function in the paired device, or for other paired devices containing a camera such as the GoPro.

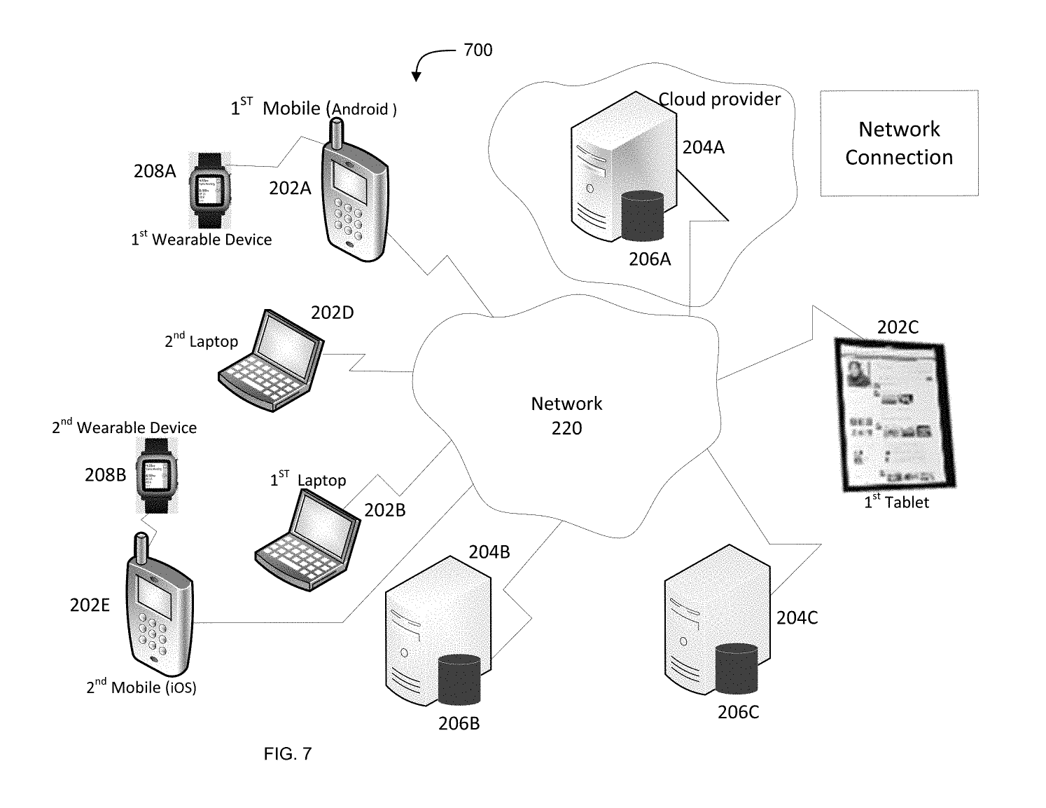

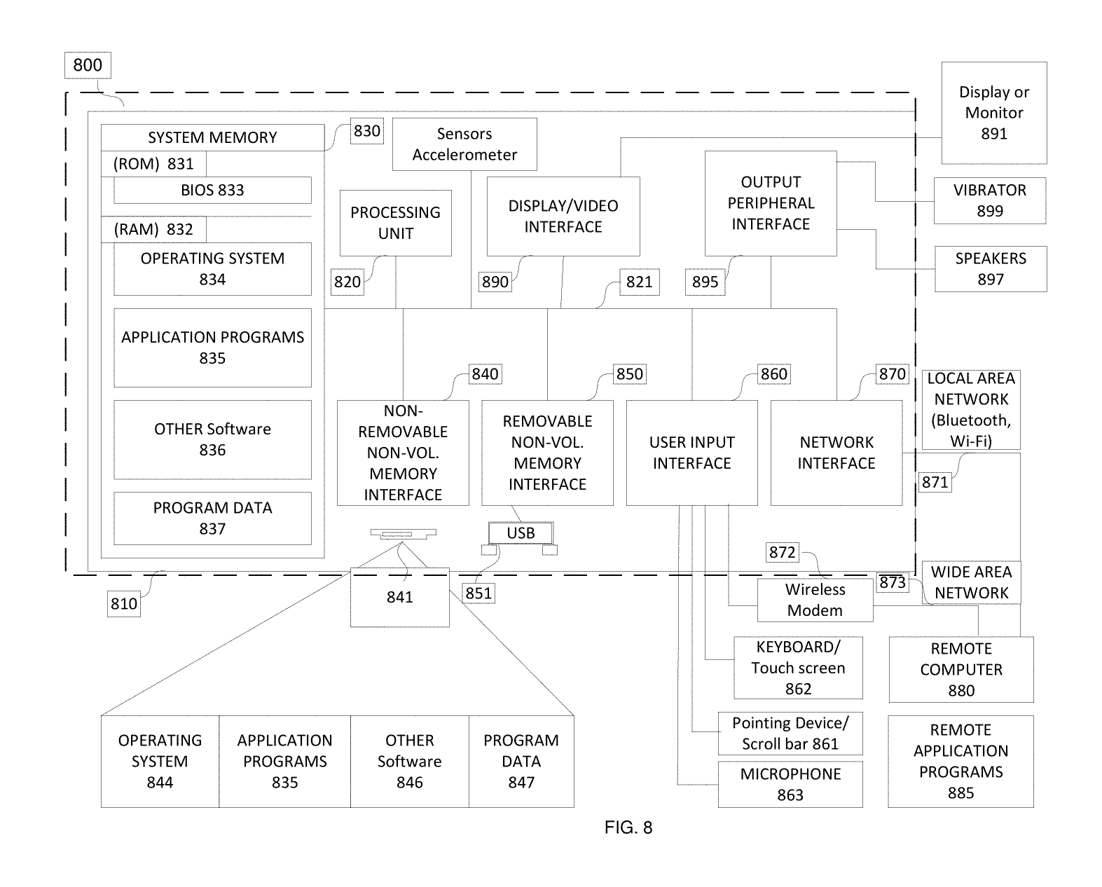

In general, the wearable electronic device includes one or more systems optionally coupled to one or more networks. FIGS. 7-8 illustrates additional example environments to implement the concepts. The wearable electronic device also has a computer readable storage medium in its housing accessible to the processor for storing instructions executable by the processor to generate the number of different operations on the onscreen display.

FIG. 8 illustrates a block diagram of an example computing system that may be used in an embodiment of one or more of the servers, a wearable electronic device, and client devices discussed herein. The computing system environment 800 is only one example of a suitable computing environment, such as a client device, server, wearable electronic device, etc., and is not intended to suggest any limitation as to the scope of use or functionality of the design of the computing system 810. Neither should the computing environment 800 be interpreted as having any dependency or requirement relating to any one or combination of components illustrated in the exemplary operating environment 800.

FIG. 9 illustrates a block diagram of an example wearable device. The block diagram 900 shows a wearable device 102 that can communicate with a mobile device such as a mobile electronic device, e.g. a smart phone 104. The wearable device includes one or more processors 976, memories 974, and ports 972. The wearable device service 960 that includes one or more routines can execute on the processors 976. The wearable device can also include a communication module 956 that can run on the processors and for communicating to outside of the wearable devices. Additionally, the wearable electronic device can have one or more of 962: an accelerometer, a magnetometer, a gyroscope, a heart rate monitor, an altimeter, and a light sensor. The wearable electronic device can further include a graphic user interface and a display screen, one or more of a speaker, a vibrator, and microphone 863.

In an embodiment, the communication module 956 can transmit wirelessly through a network to another computing device such as a mobile device 104 cooperating with the wearable electronic device. (See, for example, FIGS. 7-8). In an example, the wearable electronic device 102 and the mobile device 104 can directly communicate using Bluetooth.

FIG. 11 illustrates a block diagram of a portion of an example communication channel for requests and responses with multiple wearable electronic devices and their associated mobile electronic devices. The multiple wearable electronic devices 102 can communicate and send/receive signals with the audio-proxy server through their associated mobile electronic devices 104. Thus, the communication channel starting with the audio proxy server 106 communicates with multiple instances of the wearable device service. Each instance of the wearable device service may i) directly connect to the audio proxy server 106 or ii) connect via the partner mobile application on the corresponding mobile device 104, such as a smart phone.

In an embodiment, the wearable electronic device is an electronic smart watch that comes with an LED e-paper display, with144×168 pixels and a pixel density of 182 ppi. The wearable electronic device has a color display with a backlight as well. The wearable electronic device also has a vibrating motor for silent alarms, and smart notifications. The wearable electronic device can have a charging cable that can magnetically attach itself to the wearable electronic device in order to maintain its water resistance. The wearable electronic device can also be equipped with an ambient light sensor, a 6-axis accelerometer, etc. In an example, the wearable electronic device can have axis accelerometer with gesture detection, a vibrating motor, an ambient light sensor, a compass, a gyro meter, a magnetometer, a pedometer, a microphone, and four software or physical buttons for user input. In alternative embodiments, the display may include any number of buttons, touch screen, a scroll bar, a rotating bezel, or a combination of any of the elements for user input.

In an example, the display can have 144×168 pixel Memory LCD “e-paper”, or 144×168 pixel black and white memory LCD using an ultra-low-power “transflective LCD” with a backlight, or 1.25 inch 64-color LED backlit e-paper display.

In an embodiment, the wearable electronic device can connect through a wireless network to an app store having many applications and watch faces that can be downloaded. The applications include notifications for emails, calls, text messages & social media activity; stock prices; activity tracking (movement, sleep, estimates of calories burned); remote controls for smartphones, cameras & home appliances; turn-by-turn directions (using the GPS receiver in a smartphone or tablet); display of RSS or JSON feeds; and also include hundreds of custom watch faces.

In an embodiment, the wearable electronic device can integrates with any phone or tablet application that sends out native iOS or Android notifications.

In an embodiment, the wearable electronic device is an electronic watch and includes a small accessory port on the back of the watch face. Open hardware platform of the wearable electronic device lets developers develop new smart straps that connects to a special port at the back of the watch and can add additional features like GPS, heart rate monitors, extended battery life and other things to the watch. It enables the wearer to attach additional equipment to the watch, including sensors, batteries, etc. The information obtained from smart straps attached to the wearable electronic device can be used as the context data to be added to the meta file.

In an embodiment, the wearable electronic device is a wristwatch that has a watch housing in which the onscreen display bears a time indication, either digital or analog. In certain instances, the wristwatch may be a smart watch. In one embodiment, the wristwatch has two or more manipulatable physical buttons that are arranged on the housing of the watch. In other embodiments, the wristwatch may have a touch screen, scrolling device, additional buttons, or a combination of some or all of these. A flexible wristband can couple to the housing of the watch to hold the housing of the watch onto a wearer.

In an embodiment, the wearable electronic device can integrates with any phone or tablet application that sends out native iOS or Android notifications.

Computing system

With reference to FIG. 8, components of the computing system 810 may include, but are not limited to, a processing unit 820 having one or more processing cores, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus.

Computing system 810 typically includes a variety of computing machine-readable media. Computing machine-readable media can be any available media that can be accessed by computing system 810 including both volatile and nonvolatile media, removable and non-removable media. By way of example, and not limitation, computing machine-readable mediums uses include storage of information, such as computer readable instructions, data structures, other executable software or other data. Computer storage mediums include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by computing device 800. Transitory media such as wireless channels are not included in the machine-readable media. Communication media typically embodies computer readable instructions, data structures, other executable software, or other transport mechanism and includes any information delivery media. As an example, some clients on network 220 of FIG. 7 may not have any optical or magnetic storage.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computing system 810, such as during start-up, is typically stored in ROM 831. RAM 832 typically contains data and/or software that are immediately accessible to and/or presently being operated on by processing unit 820. By way of example, and not limitation, FIG. 8 illustrates that RAM can include a portion of the operating system 834, other executable software 836, and program data 837.

The computing system 810 may also include other removable/non-removable volatile/nonvolatile computer storage media. By way of example only, FIG. 8 illustrates a solid-state memory 841. Other removable/non-removable, volatile/nonvolatile computer storage media that can be used in the exemplary operating environment include, but are not limited to, USB drives and devices, flash memory cards, solid state RAM, solid state ROM, and the like. The solid-state memory 841 is typically connected to the system bus 821 through a non-removable memory interface such as interface 840, and USB drive 851 is typically connected to the system bus 821 by a removable memory interface, such as interface 850. In an example, the wearable electronic device can have 128 KB of RAM, which can include 84 KB for OS, 24 KB for applications, 12 KB for background worker, and 8 KB for services. The wearable electronic device can have 8 slots for apps/watch faces, with 100 KB per slot for a total of 800 KB user accessible space. In another example, the wearable electronic device can have between 4 MB and 32 Megabits of flash memory.

As an example, the computer readable storage medium 841 stores Operating System software for smart watches to cooperate with both Android OS and iOS.

The drives and their associated computer storage media discussed above and illustrated in FIG. 8, provide storage of computer readable instructions, data structures, other executable software and other data for the computing system 810. In FIG. 8, for example, the solid state memory 841 is illustrated for storing operating system 844, other executable software 846, and program data 847. Note that these components can either be the same as or different from operating system 834, other executable software 836, and program data 837. Operating system 844, other executable software 846, and program data 847 are given different numbers here to illustrate that, at a minimum, they are different copies. In an example, the operating system, Pebble OS, can be a customized Free RTOS kernel that can communicate with Android and iOS apps using Bluetooth.

A user may enter commands and information into the computing system 810 through input devices such as a keyboard, touchscreen, or even push button input component 862, a microphone 863, a pointing device and/or scrolling input component 861, such as a mouse, trackball or touch pad. The microphone 863 may cooperate with speech recognition software. These and other input devices are often connected to the processing unit 820 through a user input interface 860 that is coupled to the system bus, but may be connected by other interface and bus structures, such as a parallel port, game port or a universal serial bus (USB). A display monitor 891 or other type of display screen device is also connected to the system bus 821 via an interface, such as a display and video interface 890. In addition to the monitor, computing devices may also include other peripheral output devices such as speakers 897, a vibrator 899, and other output device, which may be connected through an output peripheral interface 890.

The computing system 810 may operate in a networked environment using logical connections to one or more remote computers/client devices, such as a remote computing device 880. The remote computing device 880 may be a wearable electronic device, a personal computer, a hand-held device, a server, a router, a network PC, a peer device or other common network node, and typically includes many or all of the elements described above relative to the computing system 810. The logical connections depicted in FIG. 8 include a local area network (LAN) 871 and a wide area network (WAN) 873, but may also include other networks. Such networking environments are commonplace in offices, enterprise-wide computer networks, intranets and the Internet. A browser application may be resident on the computing device and stored in the memory.

When used in a LAN networking environment, the computing system 810 is connected to the LAN 871 through a network interface or adapter 870, which can be a Bluetooth or Wi-Fi adapter. When used in a WAN networking environment, the computing system 810 typically includes a modem 872, e.g., a wireless network, or other means for establishing communications over the WAN 873, such as the Internet. The wireless modem 872, which may be internal or external, may be connected to the system bus 821 via the user-input interface 860, or other appropriate mechanism. In a networked environment, other software depicted relative to the computing system 810, or portions thereof, may be stored in the remote memory storage device. By way of example, and not limitation, FIG. 8 illustrates remote application programs 885 as residing on remote computing device 880. It will be appreciated that the network connections shown are exemplary and other means of establishing a communications link between the computing devices may be used.

As discussed, the computing system may include a processor, a memory, a built in battery to power the computing device, an AC power input to charge the battery, a display screen, and a built-in Wi-Fi circuitry to wirelessly communicate with a remote computing device connected to network.

It should be noted that the present design can be carried out on a computing system such as that described with respect to FIG. 8. However, the present design can be carried out on a server, a computing device devoted to message handling, or on a distributed system in which different portions of the present design are carried out on different parts of the distributed computing system.

Another device that may be coupled to bus 811 is a power supply such as a battery and Alternating Current adapter circuit. As discussed above, the DC power supply may be a battery, a fuel cell, or similar DC power source that needs to be recharged on a periodic basis. The wireless communication module 872 may employ a Wireless Application Protocol to establish a wireless communication channel. The wireless communication module 872 may implement a wireless networking standard such as Institute of Electrical and Electronics Engineers (IEEE) 802.11 standard, IEEE std. 802.11-1999, published by IEEE in 1999.

Examples of mobile computing devices may be a smart phone, a laptop computer, a cell phone, tablet, a personal digital assistant, or other similar device with on board processing power and wireless communications ability that is powered by a Direct Current (DC) power source that supplies DC voltage to the mobile device and that is solely within the mobile computing device and needs to be recharged on a periodic basis, such as a fuel cell or a battery.

### Network Environment

FIG. 7 illustrate diagrams of a network environment in which the techniques described may be applied. The network environment 700 has a communications network 220 that connects server computing systems 204A through 204C, and at least one or more client computing systems 202A to 202E. As shown, there may be many server computing systems 204A through 204C and many client computing systems 202A to 202E connected to each other via the network 220, which may be, for example, the Internet. Note, that alternatively the network 220 might be or include one or more of: an optical network, a cellular network, the Internet, a Local Area Network (LAN), Wide Area Network (WAN), satellite link, fiber network, cable network, or a combination of these and/or others. It is to be further appreciated that the use of the terms client computing system and server computing system is for clarity in specifying who generally initiates a communication (the client computing system) and who responds (the server computing system). No hierarchy is implied unless explicitly stated. Both functions may be in a single communicating device, in which case the client-server and server-client relationship may be viewed as peer-to-peer. Thus, if two systems such as the client computing system 202A and the server computing system 204A can both initiate and respond to communications, their communication may be viewed as peer-to-peer. Likewise, communications between the server computing systems 204A and 204-B, and the client computing systems 202A and 202E may be viewed as peer-to-peer if each such communicating device is capable of initiation and response to communication. Additionally, server computing systems 204A-204C also have circuitry and software to communication with each other across the network 220. One or more of the server computing systems 204A to 204C may be associated with a database such as, for example, the databases 206A to 206C. Each server may have one or more instances of a virtual server running on that physical server and multiple virtual instances may be implemented by the design. A firewall may be established between a client computing system 202A and the network 220 to protect data integrity on the client computing system 202A. Each server computing system 204A-204C may have one or more firewalls.

In an embodiment, one or more client computing systems 202A-202E can be connected to other devices via one-to-one communication connections. For example, the client devices 202A and 202E may be respectively coupled to wearable electronic devices 208A and 208B via Bluetooth connections. In another example, the client devices 202A and 202E may respectively couple to wearable electronic devices 208A and 208B via Wi-Fi connections. In an embodiment, the Network 220 can be a communication network for sending SMS and notifications.

A cloud provider service can install and operate application software in the cloud and users can access the software service from the client devices. Cloud users who have a site in the cloud may not solely manage the cloud infrastructure and platform where the application runs. Thus, the servers and databases may be shared hardware where the user is given a certain amount of dedicate use of these resources. The user's cloud-based site is given a virtual amount of dedicated space and bandwidth in the cloud. Cloud applications can be different from other applications in their scalability that can be achieved by cloning tasks onto multiple virtual machines at run-time to meet changing work demand. Load balancers distribute the work over the set of virtual machines. This process is transparent to the cloud user, who sees only a single access point.

The cloud-based remote access is coded to utilize a protocol, such as Hypertext Transfer Protocol (HTTP), to engage in a request and response cycle with both a mobile device application resident on a client device as well as a web-browser application resident on the client device. The cloud-based remote access for a wearable electronic device can be accessed by a mobile device, a desktop, a tablet device, and other similar devices, anytime, anywhere. Thus, the cloud-based remote access to a wearable electronic device hosted on a cloud-based provider site is coded to engage in 1) the request and response cycle from all web browser based applications, 2) SMS/twitter based request and response message exchanges, 3) the request and response cycle from a dedicated on-line server, 4) the request and response cycle directly between a native mobile application resident on a client device and the cloud-based remote access to a wearable electronic device, and 5) combinations of these.

In an embodiment, the server computing system 204A may include a server engine, a web page management component, a content management component, and a database management component. The server engine performs basic processing and operating system level tasks. The web page management component handles creation and display or routing of web pages or screens associated with receiving and providing digital content and digital advertisements. Users may access the server-computing device by means of a URL associated therewith. The content management component handles most of the functions in the embodiments described herein. The database management component includes storage and retrieval tasks with respect to the database, queries to the database, and storage of data.

An embodiment of a server computing system to display information, such as a web page, etc. is discussed. An application including any program modules, when executed on the server computing system 204A, causes the server computing system 204A to display windows and user interface screens on a portion of a media space, such as a web page. A user via a browser from the client computing system 202A may interact with the web page, and then supply input to the query/fields and/or service presented by a user interface of the application. The web page may be served by a web server computing system 204A on any Hypertext Markup Language (HTML) or Wireless Access Protocol (WAP) enabled client computing system 202A or any equivalent thereof. For example, the client mobile computing system 202A may be a wearable electronic device, smart phone, a touch pad, a laptop, a netbook, etc. The client computing system 202A may host a browser to interact with the server computing system 204A. Each application has a code scripted to perform the functions that the software component is coded to carry out such as presenting fields and icons to take details of desired information. Algorithms, routines, and engines within the server computing system 204A take the information from the presenting fields and icons and put that information into an appropriate storage medium such as a database. A comparison wizard is scripted to refer to a database and make use of such data. The applications may be hosted on the server computing system 204A and served to the browser of the client computing system 202A. The applications then serve pages that allow entry of details and further pages that allow entry of more details.

### Scripted Code

Note, an application, as herein described, includes but is not limited to software applications, mobile apps, a third party developed app that is managed within or part of an operation system application on its resident device.

Any application and other scripted code components may be stored on a non-transitory computing machine-readable medium which, when executed on the machine causes the machine to perform those functions. The applications including program modules may be implemented as logical sequences of software code, hardware logic circuits, and any combination of the two, and portions of the application scripted in software code are stored in a non-transitory computing device readable medium in an executable format. In an embodiment, the hardware logic consists of electronic circuits that follow the rules of Boolean Logic, software that contain patterns of instructions, or any combination of both.

The design is also described in the general context of computing device executable instructions, such as applications etc. being executed by a computing device. Generally, application programs include routines, objects, widgets, plug-ins, and other similar structures that perform particular tasks or implement particular abstract data types. Those skilled in the art can implement the description and/or figures herein as computer-executable instructions, which can be embodied on any form of computing machine-readable media discussed herein.

Some portions of the detailed descriptions herein are presented in terms of algorithms/routines and symbolic representations of operations on data bits within a computer memory. These algorithmic descriptions and representations are the means used by those skilled in the data processing arts to most effectively convey the substance of their work to others skilled in the art. An algorithm/routine is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms/routine of the application including the program modules may be written in a number of different software programming languages such as C, C++, Java, HTML, or other similar languages.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computing system, or similar electronic computing device that manipulates and transforms data represented as physical (electronic) quantities within the computing system's registers and memories into other data similarly represented as physical quantities within the computing system memories or registers, or other such information storage, transmission or display devices.

Although embodiments of this design have been fully described with reference to the accompanying drawings, it is to be noted that various changes and modifications will become apparent to those skilled in the art. Such changes and modifications are to be understood as being included within the scope of embodiments of this design as defined by the appended claims. For example, the device may include multiple microphones and the multiple microphones may be used for noise cancellation. The invention is to be understood as not limited by the specific embodiments described herein, but only by scope of the appended claims.

What is claimed is:

1. A system for routing verbal requests of a user of a wearable electronic device that is wirelessly coupled to an associated mobile electronic device, comprising:
a wearable device service has data and one or more routines, storable in a first memory in the wearable electronic device in an executable format, where the routines of the wearable device service are configured to be executed by one or more processors in the wearable electronic device, where the wearable device service is configured to establish a wireless communication link and cooperate with a partner mobile application in the associated mobile electronic device, where the routines of the wearable device service are configured to capture a stream of audio segments corresponding to a verbal request of a user of the wearable electronic device, where the wearable device service cooperates with a microphone in the wearable electronic device to generate the stream of audio segments corresponding to the verbal request of the user, where the wearable device service is configured to send the stream of audio segments of the user to the associated mobile electronic device; where the wearable device service is configured to communicate with an intelligent agent, which includes any combination of an artificial intelligence engine and a human operator, to handle the verbal request along with the audio segments corresponding to the verbal request from the user of the wearable electronic device and fulfill that request, where the intelligent agent is configured to analyze the streamed audio segments corresponding to the verbal request, where the intelligent agent communicates back with the wearable device service with one or more response to facilitate and carry out the verbal request from the user of the wearable electronic device.

2. The system of claim 1, where the partner mobile application has data and one or more routines, storable in a second memory in the associated mobile electronic device in an executable format, where the routines of the partner mobile application are configured to be executed by one or more processors in the associated mobile electronic device, where the partner mobile application of the associated mobile electronic device is configured to receive the stream of audio segments associated with the verbal request of the user from the wearable device service of the wearable electronic device, where the partner mobile application is configured to communicate with an audio-proxy server and to send the stream of audio segments to an audio-proxy server, where the audio-proxy server is configured to send the stream of audio segments to both an audio store and a speech to text server.

3. The system of claim 1, the audio-proxy server is configured to time multiplex the received stream of audio segments from the mobile electronic device, where the audio-proxy server is coupled to a speech-to-text server and configured to bi-directionally communicate with the speech-to-text server, where the speech-to-text server is configured to receive the multiplexed stream of audio segments and to perform speech-to-text techniques, such as a speech recognition process, on the time multiplexed stream of audio segments and generate a voice-to-text file from the time multiplexed stream of audio segments, where a set of text words in the voice-to-text file correspond to spoken words of the verbal request from the user.

4. The system of claim 3, where, after the speech-to-text technique, the speech-to-text server is configured to send back the voice-to-text file to the audio-proxy server, where the audio-proxy server is configured to receive back the speech to text file and send the speech to text file to the wearable device service via the partner mobile application.

5. The system of claim 2, wherein the audio-proxy server includes one or more routines executing on one or more processors, where the audio-proxy server is configured to receive the stream of audio segments from the partner mobile application, where the audio-proxy server is configured to perform time multiplexing of the received stream of audio segments and create a time-multiplexed stream of audio segments to send to an audio store server; and
where the audio store server is configured to compile and convert the audio segments into an audio file, where the audio-proxy server is configured to send the audio file associated with the voice-to-text file to a voice API server.

6. The system of claim 2, wherein the audio-proxy server is coupled to an audio-store server, where the audio-proxy server is further configured to create one or more audio files from the time-multiplexed stream of audio segments, where each audio file is configured to be associated with the stream of audio segments corresponding to one or more verbal requests of each user;
wherein the audio-store server includes one or more databases, and where audio-proxy server is configured to send one or both of the audio files and the time-multiplexed stream of audio segments to the audio-store server to be stored in the databases; and
wherein the audio-proxy server is configured to send the audio files to the mobile electronic devices to be attached to corresponding meta files when sent by the mobile electronic devices to the voice-API server for facilitating and carrying out the verbal requests.

7. The system of claim 5, wherein the voice-API server includes one or more routines executing on one or more processors, wherein the voice-API server is configured to collect and route verbal requests of users, where the voice-API server is configured to receive both i) the first meta file from the associated mobile electronic device and ii) the first audio file associated with the first meta file directly from a database of the audio-store server, where the voice-API server is configured to implement the first verbal request of the user based on one or both of the first meta file and the first audio file.

8. The system of claim 5, wherein the voice-API server is configured to analyze the first meta file to find out what is an appropriate service in response to the first request of the user, where a first service of the voice-API server is configured to extract the voice-to-text files from the meta files and to implement natural language processing to parse the voice-to-text files, where the first service of the voice-API server is configured to utilize a tree of categories of possibilities of services to handle or service the incoming requests.

9. The system of claim 8, wherein the voice-API server is configured to receive a first probability of accuracy corresponding to each voice-to-text file, where based on the first probability of accuracy,
i) to package the first meta file and the corresponding audio file and send the package to a third-party website when the first probability of accuracy is above or equal to a first threshold, where the third-party website is configured to route the first request, and where the third-party website is configured to send a reply to an intelligent agent service executing on a concierge server; or
ii) to package the first meta file and the corresponding audio file and send the package to the intelligent agent service executing on the concierge server when the first probability of accuracy is less than the first threshold, where the intelligent agent service or a human operator is configured to analyze the first voice-to-text file and the corresponding audio file and to route the first request.

10. The system of claim 9, wherein after routing the first request, the concierge server is further configured to send a response to the voice-API server, where the API server is then configured to route the response through either of i) a cloud-based SMS server, or 2) a cloud-based notification server to the mobile electronic device, where the mobile electronic device is configured to send the response to the associated wearable electronic device.

11. The system of claim 10, wherein the routing of the response by the API server through either of i) a cloud-based SMS server, or 2) a cloud-based notification server is based on either communication reliability, promptness of communication, or type and content of the response.

12. The system of claim 1, wherein the audio store has captured the audio file which is then sent and joined with the text of the verbal request so that the third party service and/or concierge service can facilitate and carrying out the verbal request.

13. The system of claim 3, where an intelligent agent, such an artificial intelligence engine and/or a human operator, at the concierge service will handle the verbal request from the user of the wearable electronic device and fulfill that request.

14. A method of routing requests of a user of a wearable electronic device associated with a mobile electronic device, comprising:
executing a wearable device service on one or more processors of the wearable electronic device, where the wearable device service includes data and one or more routines storable in an executable format in a first memory of the wearable electronic device; the wearable device service performing:
cooperating with the associated mobile electronic device,
capturing, stream of audio segments corresponding to verbal requests of the user of the wearable electronic device, the stream of audio segments generated by a microphone, and
sending the stream of audio segments of the user to the associated mobile electronic device;
executing a partner mobile application on one or more processors of the associated mobile electronic device, where the partner mobile application includes data and one or more routines storable in an executable format in a second memory in the associated mobile electronic device; the partner mobile application performing:
receiving, a first stream of audio segments associated with a first verbal request of the user from the wearable device service of the wearable electronic device,
communicating with an audio-proxy server and sending the first audio stream to the audio-proxy server,
in response, receiving a first voice-to-text file from the audio-proxy server, where the first voice-to-text file is a result of performing a speech-to-text technique on the first stream of audio segments,
receiving a first audio file from the audio-proxy server, where the first audio file is generated from the first stream of audio segments, and
sending the first voice-to-text file to the wearable device service of the wearable electronic device;
after receiving the first voice-to-text file, the wearable device service of the wearable electronic device further performing:
attaching context data including one or more of a user ID and a location of the user to the first voice-to-text file and creating a first meta file, and
sending the first meta file to the associated mobile electronic device; and
sending the first meta file and the first audio file by the associated mobile electronic device to a voice-API server for facilitating and carrying out the first verbal request of the user.
